(19) United States
(12) Patent Application Publication
(10) Pub. No.: US 2018/0299012 A1
(43) Pub. Date: Oct. 18, 2018

(54) SEAL DEVICE FOR CYLINDRICAL COMPONENT

(71) Applicant: Swagelok Company, Solon, OH (US)

(72) Inventors: Peter C. Williams, Cleveland Heights, OH (US); Stephen J. Zaborszki, Northfield Center, OH (US); Elizabeth Mueller, Cleveland Heights, OH (US); Ronald P. Campbell, Shaker Heights, OH (US); Douglas S. Welch, Chesterland, OH (US)

(21) Appl. No.: 15/952,290

(22) Filed: Apr. 13, 2018

Related U.S. Application Data
(60) Provisional application No. 62/485,466, filed on Apr. 14, 2017.

(51) Int. Cl. F16J 15/10

(52) U.S. Cl. CPC F16J 15/104

(57) ABSTRACT

A seal device is provided for sealing a cylindrical component upon axial insertion of the cylindrical component, with the seal device including an annular flange portion defining a first opening having a first diameter, and a skirt portion integral with the annular flange portion and extending axially and radially inward from the flange portion. The skirt portion includes a plurality of first sectors extending axially inward from the flange portion to an axially inner edge of the skirt portion, each having an inner undulation defining a second opening having a second diameter smaller than the first diameter. The plurality of first sectors are circumferentially spaced apart by a plurality of second sectors extending axially outward from the flange portion to the axially inner edge of the skirt portion, each having an outer undulation defining a third opening having a third diameter smaller than the first diameter.

### CROSS-REFERENCE TO RELATED APPLICATION

This application claims priority to and all benefit of U.S. Provisional Patent Application Ser. No. 62/485,466, filed on Apr. 14, 2017, for SEAL DEVICE FOR CYLINDRICAL COMPONENT, the entire disclosure of which is fully incorporated herein by reference.

### TECHNICAL FIELD OF THE DISCLOSURE

The inventions relate generally to annular seals for cylindrical components. More particularly, the inventions relate to annular seals for conduit fittings that provide single action push to connect operation.

### SUMMARY OF THE EXEMPLARY EMBODIMENTS

In an exemplary embodiment, a seal device is provided for sealing a cylindrical component upon axial insertion of the cylindrical component, with the seal device including an annular flange portion defining a first opening having a first diameter, and a skirt portion integral with the annular flange portion and extending axially and radially inward from the flange portion. The skirt portion includes a plurality of first sectors extending axially inward from the flange portion to an axially inner edge of the skirt portion, each having an inner undulation defining a second opening having a second diameter smaller than the first diameter. The plurality of first sectors are circumferentially spaced apart by a plurality of second sectors extending axially inward from the flange portion to the axially inner edge of the skirt portion, each having an outer undulation defining a third opening having a third diameter smaller than the first diameter.

In another exemplary embodiment, a push to connect fitting assembly includes a fitting body having an outboard end that is adapted to receive a conduit end, and a seal device disposed in an interior cavity of the fitting body. The seal device includes an annular flange portion joined with the fitting body and defining a first opening having a first diameter, and a skirt portion extending axially and radially inward from the annular flange portion to define a second opening having a second diameter smaller than the first diameter. When a conduit having a diameter smaller than the first diameter and larger than the second diameter is axially inserted through the first opening and against an interior surface of the skirt portion, the skirt portion is elastically radially expanded by the conduit to form a continuous circumferential seal around the conduit.

In another exemplary embodiment, a method of making a seal device for sealing a cylindrical component upon axial insertion of the cylindrical component is contemplated. In the exemplary method an annular flange portion is formed, defining a first opening having a first diameter. A skirt portion integral with the annular flange portion is formed, the skirt portion extending axially and radially inward from the flange portion. The skirt portion includes a plurality of first sectors extending axially inward from the flange portion to an axially inner edge of the skirt portion, each having an inner undulation defining a second opening having a second diameter smaller than the first diameter. The plurality of first sectors are circumferentially spaced apart by a plurality of second sectors extending axially inward from the flange portion to the axially inner edge of the skirt portion, each having an outer undulation defining a third opening having a third diameter smaller than the first diameter.

In another exemplary embodiment, a method of providing a push-to-connect seal between a conduit end and a fitting is contemplated. In the exemplary method, a fitting is provided, including a fitting body having an outboard end that is adapted to receive a conduit end, and a seal device disposed in an interior cavity of the fitting body, the seal device comprising an annular flange portion joined with the fitting body and defining a first opening having a first diameter, and a skirt portion extending axially and radially inward from the annular flange portion to define a second opening having a second diameter smaller than the first diameter. A conduit having a diameter smaller than the first diameter and larger than the second diameter is axially inserted through the first opening and against an interior surface of the skirt portion, such that the skirt portion is elastically radially expanded by the conduit to form a continuous circumferential seal around the conduit.

These and additional aspects and embodiments of the inventions will be understood by those skilled in the art from the following detailed description of the exemplary embodiments in view of the accompanying drawings.

### BRIEF DESCRIPTION OF THE DRAWINGS

FIG. 1 is a cross-sectional schematic view of a push-to-connect fitting assembly, in accordance with an exemplary embodiment of the present application;

FIG. 2 is a cross-sectional schematic view of the fitting assembly of FIG. 1, shown with a conduit installed in the fitting assembly;

FIG. 3 is a cross-sectional schematic view of a push-to-connect fitting assembly, in accordance with another exemplary embodiment of the present application;

FIG. 4 is a cross-sectional schematic view of the fitting assembly of FIG. 3, shown with a conduit installed in the fitting assembly;

FIG. 5 is a perspective view of a seal device for sealing a cylindrical component upon axial insertion of the cylindrical component, in accordance with an exemplary embodiment of the present application;

FIG. 6 is an end view of the seal device of FIG. 5;

FIG. 7 is a cross-sectional view of the seal device of FIG. 5, taken through a sealing inner undulation of a skirt portion of the seal device;

FIG. 8 is another cross-sectional view of the seal device of FIG. 5, taken through a sealing outer undulation of the seal device skirt portion;

FIG. 9 is a cross-sectional view of a push-to-connect fitting assembly, in accordance with an exemplary embodiment of the present application, including the seal device of FIG. 5;

FIG. 9A is a cross-sectional view of another push-to-connect fitting assembly, in accordance with another exemplary embodiment of the present application, including the seal device of FIG. 5;

FIG. 9B is a cross-sectional view of another push-to-connect fitting assembly, in accordance with another exemplary embodiment of the present application, including the seal device of FIG. 5;

FIG. 10 is a perspective view of a seal device for sealing a cylindrical component upon axial insertion of the cylindrical component, in accordance with another exemplary embodiment of the present application;

FIG. 11 is a perspective view of a seal device for sealing a cylindrical component upon axial insertion of the cylindrical component, in accordance with another exemplary embodiment of the present application;

FIG. 12 is a cross-sectional view of a push-to-connect fitting assembly, in accordance with an exemplary embodiment of the present application, including the seal device of FIG. 11;

FIG. 13 is a cross-sectional view of a seal device for sealing a cylindrical component upon axial insertion of the cylindrical component, in accordance with another exemplary embodiment of the present application;

FIG. 14 is a cross-sectional view of a seal device for sealing a cylindrical component upon axial insertion of the cylindrical component, in accordance with yet another exemplary embodiment of the present application;

FIG. 15 is a partial cross-sectional view of another seal device for sealing a cylindrical component upon axial insertion of the cylindrical component, in accordance with another exemplary embodiment of the present application; and

FIG. 16 is a partial end view of the seal device of FIG. 15.

### DETAILED DESCRIPTION OF EXEMPLARY EMBODIMENTS

Herein, the terms fitting and fitting assembly are used interchangeably. In various exemplary embodiments, a fitting assembly structure as taught herein is separately claimed as an invention without requiring the conduit to be part of the fitting assembly, and further without requiring that the various parts be in a fully assembled condition (such as may be the case, for example, of the assembly parts being shipped from a manufacturer or distributor.) In at least one embodiment, a fitting assembly includes a first fitting component or subassembly having a seal device and a second fitting component or subassembly having a retainer. In any of the embodiments described herein, the conduit does not require treatment or modification from stock condition, although optionally such may be done if needed in particular applications. For example, it is common for the conduit end to be cut substantially perpendicular to the conduit longitudinal axis and deburred as needed, but even these common steps are optional and not required to achieve conduit grip and fluid tight seal. By stock condition is meant that the conduit may be a conventional hollow right cylinder having a cylindrical inner surface that may be exposed to fluid (for example, liquid, gas or other flowable material) contained by the conduit, and a cylindrical outer surface, with a wall thickness defined as the difference between the inner diameter and the outer diameter of the conduit. The conduit may be made of any material, is preferably metal, and more preferably is a stainless steel alloy, but the inventions are not limited to these exemplary materials and other alternative materials may be used as needed for particular applications. Although traditional hollow cylindrical conduits are preferred, other conduit shapes and geometry may alternatively be used for either the outer wall or inner wall or both walls of the conduit. The word conduit herein refers to traditional tube and pipe but also includes other hollow fluid carrying structures that might be referred to by another word other than tube or pipe.

We also use the terms inboard and outboard for reference purposes only. By inboard we mean towards the center or closed end of the fitting assembly or fitting component along the reference axis, and by outboard we mean away from the center or towards the open end of the fitting assembly or fitting component along the reference axis.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 5%, or within 10%, or within 20% of the specified value, unless expressly stated otherwise. Further, it is to be understood that the drawings accompanying the present application may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

The present application contemplates sealing devices for providing a radial fluid seal on the outer diameter of a cylindrical component (e.g., valve or actuator stem, fluid conduit) inserted through the seal device. In one embodiment, the seal device is provided in a conduit fitting to provide for or allow single action push to connect operation, used interchangeably with “push-to-connect” herein. By single action is meant that a conduit, and in particular the end portion of the conduit end, can be inserted into the fitting assembly with a single dimensional or directional movement or action, and when fully inserted the conduit is sealed against fluid pressure and is retained in position. The axial insertion may be performed manually or by a tool or machine. By push to connect is meant that the single action may be a simple axial movement or push along the longitudinal axis of the conduit and that this single action is the only action needed to complete the mechanical connection between the conduit and the fitting assembly. No subsequent or additional motion or action is needed to complete the mechanical connection and fluid tight seal. In an exemplary embodiment, the single directional action or movement is an axial movement along a longitudinal axis of the conduit. No other or additional or subsequent manual or tool action or movement of the fitting assembly components is needed to achieve conduit seal and retention. Thus, a single action push to connect fitting is distinguished from a traditional fitting assembly that typically is pulled-up or tightened to effect conduit grip and seal by relative movement of the fitting assembly components after insertion of the conduit; for example, a body and a nut that are joined by a threaded mechanical connection and pulled-up by relative rotation of the body and nut, or by being clamped together without a threaded mechanical connection.

Exemplary push-to-connect fittings are described in U.S. Patent Application Publication Nos. 2013/0119659 (the “'659 Application”), 2013/0207385 (the “'385 Application”), 2015/0115602 (the “'602 Application”), and 2016/0312932 (the “'932 Application”), the entire disclosures of each of which are incorporated herein by reference.

In a push-to-connect fitting, an annular seal device provides a circumferential fluid tight seal between the fitting and the inserted conduit, as described in the above incorporated publications. In some embodiments, an elastomeric seal device (e.g., o-ring, gasket) installed in the fitting provides a fluid tight seal against fluid pressure between the outer surface of the conduit and the fitting body when the conduit is inserted into the fitting body, by being compressed between the outer surface of the conduit and one or more surfaces of the fitting body. In some applications, fluid system conditions (e.g., system temperature, system pressure, fluid compatibility) may make the use of an elastomeric fitting component undesirable.

According to an aspect of the present application, an annular seal device (for example, for use with a push-to-connect fitting) may be provided with a metal (or other non-elastomeric material) sealing device configured to seal around or against a cylindrical component (e.g., conduit, valve/actuator stem) upon axial insertion of the cylindrical component through the seal device. To allow for use of a seal material having a lower range of elastic deformation, as compared to an elastomer, the seal device may be provided with an axially and radially inward extending wall or skirt portion that is elastically radially expanded or flexed outward by the cylindrical component when the cylindrical component is axially inserted into the seal device and pressed against an interior surface of the skirt portion.

Herein, the terms axis or axial and derivative forms thereof refer to a longitudinal axis X along which a conduit C will be inserted and retained. Reference to radial and radial direction and derivative terms also are relative to the X axis unless otherwise noted. In the illustrated embodiments, the axis X may be the central longitudinal axis of the conduit C which also may but need not correspond with or be coaxial with the central longitudinal axis of the fitting assembly. The conduit C may be any conduit that defines a flow path FP for system fluid that is contained by the conduit C and the fitting. The inventions and embodiments described herein are particularly suitable for metal conduit such as metal pipe or tube, however, non-metal conduits may also be used as needed. The conduit C may have any range of diameter size, for example, 1/16th inch or less to 3 inches or greater in diameter and may be in metric or fractional sizes. The conduit C may also have any range of wall thickness accommodating desired ranges of fluid flow rate and pressure containment.

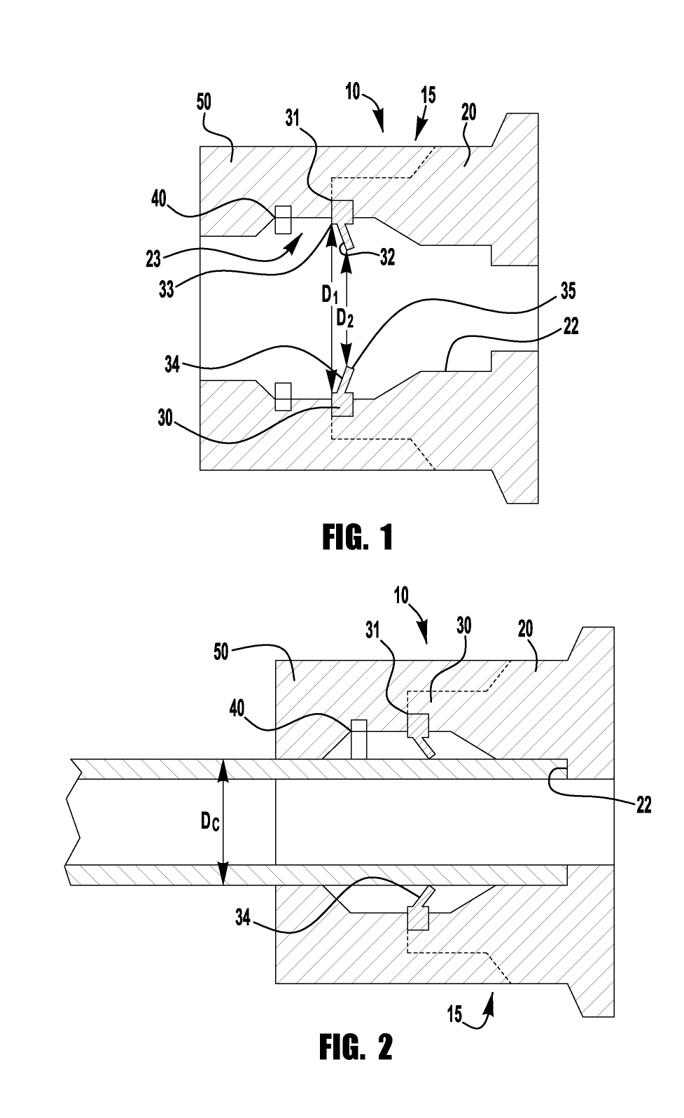

FIGS. 1 and 2 schematically illustrate an exemplary push-to-connect fitting 10 having a fitting body 15 and a seal device 30 for providing a circumferential seal between the fitting body and a conduit C inserted into a socket 22 in an outboard end of the fitting body 15 (FIG. 2). The seal device 30 is disposed in an interior cavity 23 of the fitting body surrounding the socket 22, and includes an annular flange portion 31 joined with the fitting body 15 and defining a first opening 33 having a first diameter D₁. As shown, the first opening may be sized to receive the conduit C therethrough, with the first diameter D₁ being larger than the conduit diameter D_{C}. The seal device 30 itself may be 3D printed, thixo-formed, metal injection molded, stamped, warm formed, hydro formed, or fabricated by similar technologies. The flange portion 31 may be integrally formed with the fitting body 15 to provide a seal between the flange portion 31 and the body cavity 23. Three-dimensional (3D) printing or other additive manufacturing techniques may be utilized to form a fitting body having an integral seal device as described herein. In other embodiments, the seal device 30 may be assembled with the fitting body 15 such that a seal is formed between the flange portion 31 and the fitting body, as described in greater detail below. To facilitate assembly of the seal device 30 with the fitting body 15, the fitting body 15 may be formed from first and second fitting components 20, 50 assembled together such that the first and second fitting components 20, 50 together define the seal device retaining cavity 23. While many different arrangements may be utilized for assembly of the fitting components to form the fitting body (e.g. welding, clamping, crimping), in one embodiment, the second fitting component 50 may be a threaded nut (e.g., female threaded) that is threadably assembled with a threaded portion (e.g., male threaded) of the first fitting component 20, similar to the embodiments described in the above incorporated '659, '385, '602, and '932 Applications.

The exemplary seal device includes a skirt portion 34 extending axially and radially inward from the flange portion 31 to define a second opening 35 having a second diameter D₂ smaller than the first diameter D₁ and smaller than the conduit diameter D_{C}. When the conduit C is axially inserted into the socket 22 of the fitting body 15, through the first opening 33 of the seal device 30, and against an interior surface 32 of the skirt portion 34, the skirt portion is elastically radially expanded or flexed outward by the conduit C. The elastic inward radial bias of the flexed skirt portion forms a continuous circumferential seal between the interior surface 32 of the skirt portion 34 and the conduit C.

While the elastic inward radial bias of the flexed skirt portion may additionally provide a gripping force for retaining the inserted conduit C in the fitting body 15 against system pressure, in some embodiments, the fitting 10 may include a separate retainer (shown schematically at 40) assembled with the fitting body 15 and configured to grip and/or collet the inserted conduit C. Exemplary retainer arrangements are described in the above incorporated '659, '385, '602, and '932 Applications. To facilitate assembly of the retainer 40 with the fitting body 15, the retainer may be axially captured between the fitting body 15 and a fitting component 50 assembled with the fitting body (as described above), similar to the embodiments described in the above incorporated '659, '385, '602, and '932 Applications.

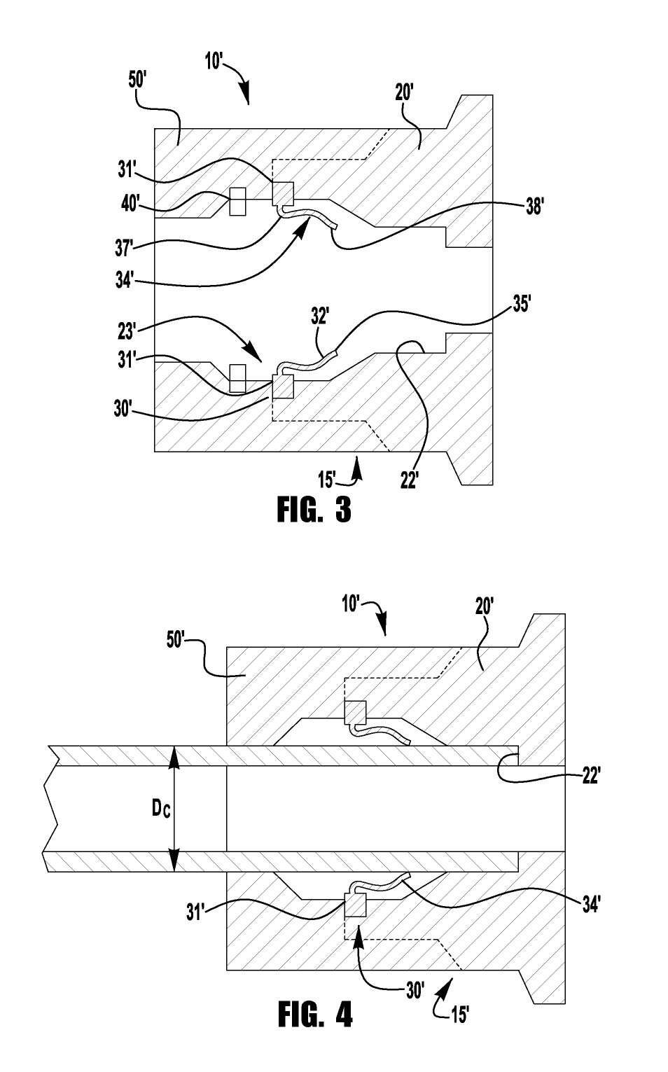

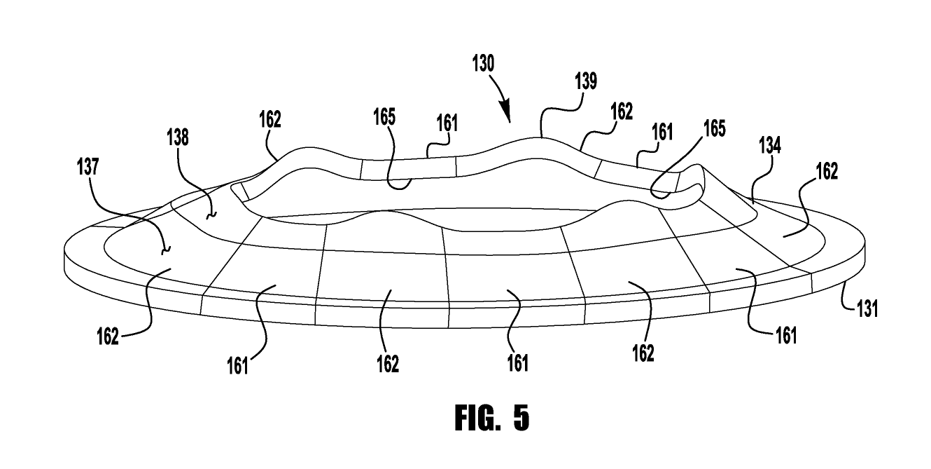

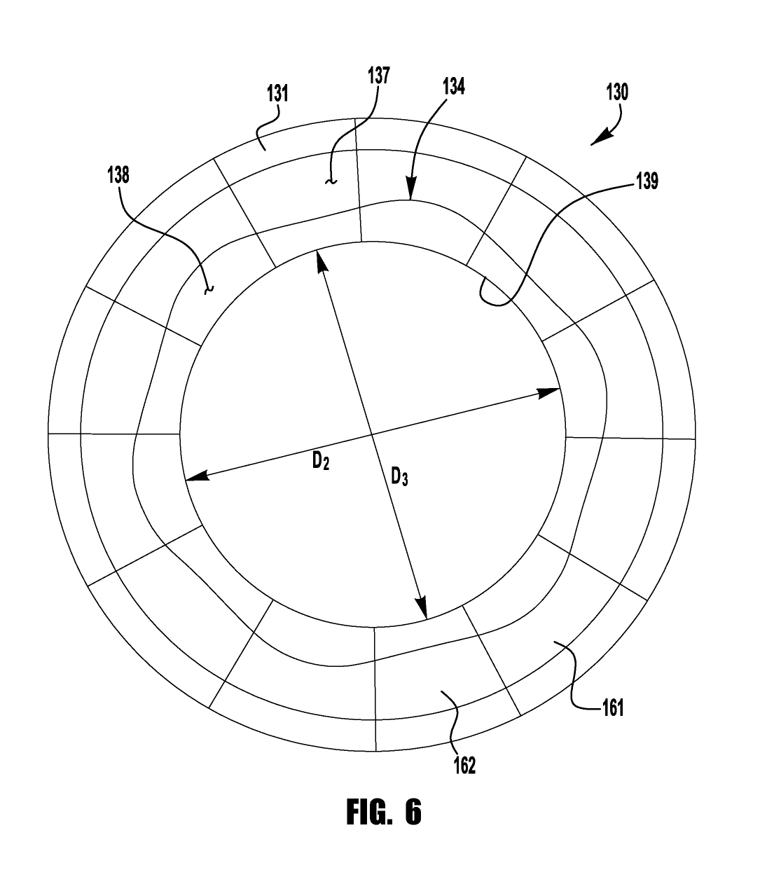

While the skirt portion may extend uniformly radially inward along its entire axial length, in other embodiments, the angle of skirt portion may vary along its axial length. As one example, the skirt portion may include a proximal portion that extends radially inward at a first steeper angle (e.g., between about 30° and about 60°, or about 45°), and a distal portion that extends radially inward at a second shallower angle (e.g., between about 40° and about 80°, or about)60°, similar to the exemplary seal device shown in FIG. 5 and described in greater detail below. In another embodiment, as shown in FIGS. 3 and 4, a fitting 10′ may be provided with a seal device 30′ having a skirt portion 34′ that includes a proximal portion 37′ that extends radially outward at a first angle (e.g., between about 0° and about 20° , or about 10°), and a distal portion 38′ that extends radially inward at a second angle (e.g., between about 10° and about 50°, or about 30°), such that the skirt portion 34′ forms a barrel shape.

The exemplary seal devices may be provided in a variety of suitable materials, including, but not limited to, any one or more of: high yield tensile strength steels (e.g., A514, A588, A852, etc.), 316 stainless steel, 300 stainless steel, 400 stainless steel, 6 Moly stainless steel, Inconel 625, Incoloy 825, brass, copper alloy, low alloy steels, aluminum, aluminum alloys, titanium, magnesium, gold, silver platinum, plutonium, uranium, tantalum, nickel, zinc, tin, and plastic. To provide suitable elastic radial expansion of the seal device skirt portion, many factors may be considered. For example, the seal device skirt portion may be provided in a material selected to provide high yield strength, such as, for example, high yield tensile strength steels (e.g., A514, A588, A852, etc.). As another example, at least the skirt portion of the seal device may be provided in a material selected to have a sufficiently low elastic modulus (e.g., an elastic modulus of about 3 million psi to about 35 million psi), to allow for a relatively low force for tube insertion into and through the seal opening. For example, stainless steels, nickel, tantalum, and high tensile yield strength steels have an elastic modulus of about 27 million psi to about 31 million psi; copper alloys and titanium have an elastic modulus of about 14 million psi to about 18 million psi; and aluminum, aluminum alloys, magnesium, zinc, and tin have an elastic modulus of about 6 million psi to about 10 million psi. As still another example, the seal device skirt portion may be provided with a wall thickness that is thin enough to provide sufficiently low loads of conduit insertion, but thick enough to not collapse under intended fluid pressure. In various exemplary embodiments, suitable wall thicknesses include 0.001 to 0.010 inches. As yet another example, the seal device skirt portion may include an interior surface disposed at an angle that is steep enough to provide sufficient elastic radial expansion, but shallow enough to limit the required insertion force of the conduit during installation. In various exemplary embodiments, suitable taper angles include approximately 20° to approximately 70° with respect to the central axis X.

While the skirt portion of a seal device may be circumferentially uniform, in some applications, the bulk compression and tensile stressing of the skirt portion required for radial elastic expansion of such a circumferentially uniform skirt portion may result in excessive installation forces and may require unreasonably exacting tolerances for the conduit outer diameter and surface finish in order to provide a reliable circumferential seal around the inserted conduit. According to another aspect of the present application, in some embodiments, a seal device may be provided with a circumferentially non-uniform elastically expandable skirt portion having alternating inner and outer radial portions at a first axial location, with the inner radial portions defining a second opening that is more easily radially expanded, as compared to a circumferentially continuous skirt portion defining a uniform opening. In one such embodiment, a skirt portion of a seal device includes one or more first sectors (e.g., between 1 and 60 first sectors) defining the inner radial portions, circumferentially spaced apart by one or more second sectors (e.g., between 1 and 60 second sectors) defining the outer radial portions. The alternating inner and outer radial portions may be formed in a variety of configurations. In one embodiment, undulations around the circumference of the skirt portion form “valleys” defining the inner radial portions on the first sectors and “peaks” defining the outer radial portions on the second sectors.

FIGS. 5-8 illustrate an exemplary flanged conical seal device 130 (similar to the sealing device 30 of FIGS. 1 and 2) including an annular flange portion 131 defining a first opening 133 having a first diameter D₁, sized for insertion of a conduit C (or other cylindrical component) through the annular flange portion, and a skirt portion 134 integral with the annular flange portion 131 and extending axially and radially inward from the flange portion. The skirt portion 134 includes a proximal portion 137 that extends radially inward at a first steeper angle, and a distal portion 138 that extends radially inward at a second shallower angle, for example to facilitate radially outward flexing of the skirt portion by the inserted conduit C.

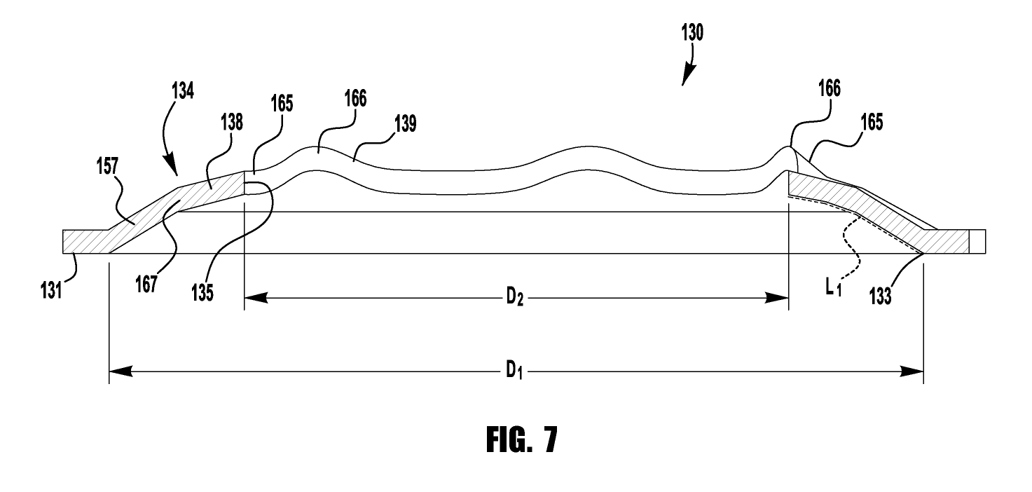

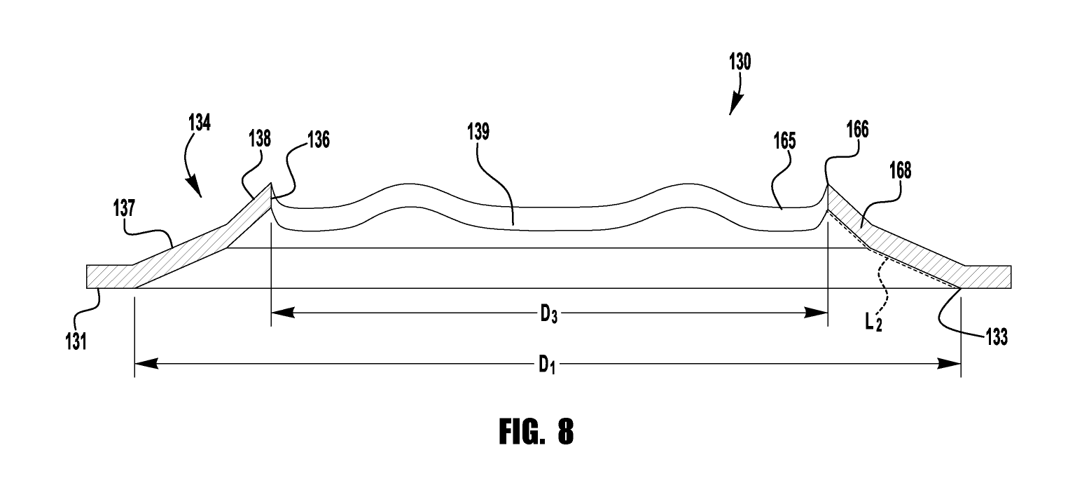

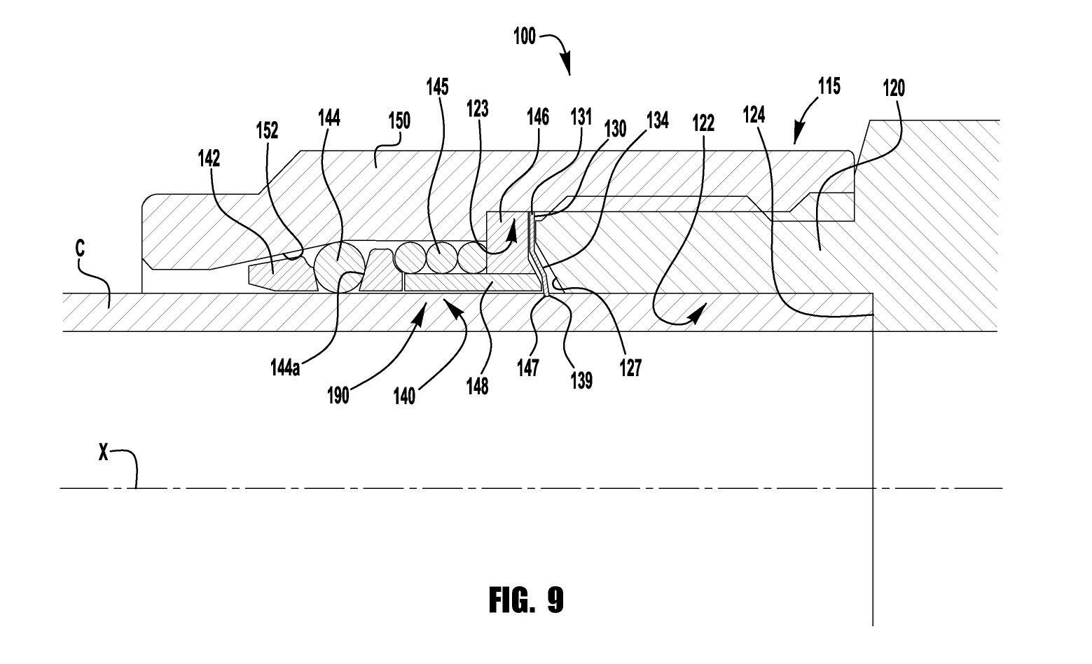

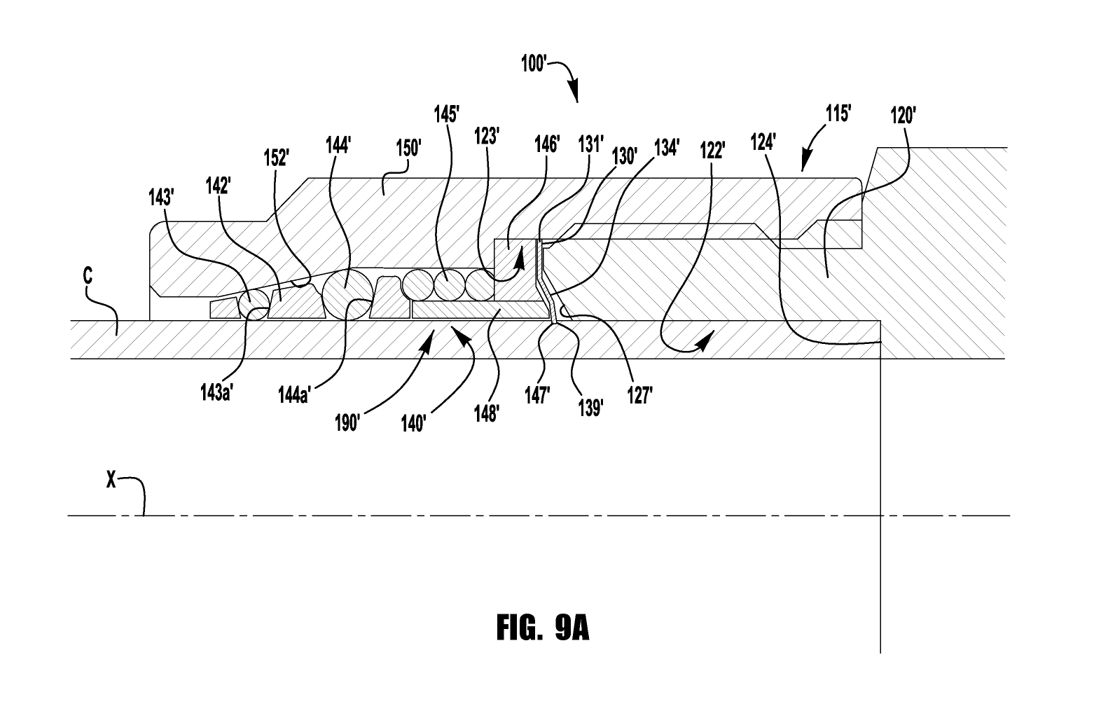

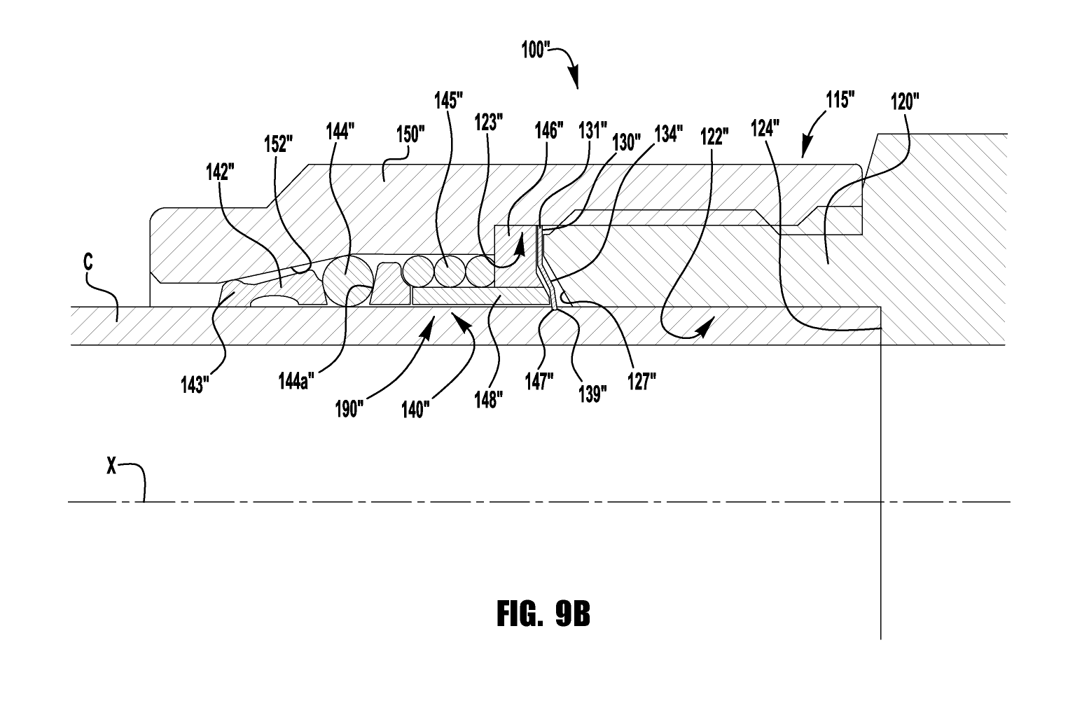

The skirt portion 134 includes a plurality of first sectors 161 extending axially inward from the flange portion to an axially inner edge 139 of the skirt portion. Each of the first sectors 161 includes an inner undulation 165 (or “valley”), with the inner undulations together defining a second opening 135 (see FIG. 7) having a second diameter D₂ smaller than the first diameter D₁, and smaller than the outer diameter D_{C} of the inserted conduit C (see FIG. 9). The first sectors 161 are circumferentially spaced apart by a plurality of second sectors 162 extending axially inward from the flange portion 131 to the axially inner edge 139 of the skirt portion 134. Each of the second sectors 162 includes an outer undulation 166 (or “peak”), with the outer undulations together defining a third opening 136 (see FIG. 8) having a third diameter D₃ smaller than the first diameter D₁ and smaller than the outer diameter D_{C} of the inserted conduit C (see FIG. 9).

The seal device 130 may be configured such that when a conduit C (or other cylindrical component), having a diameter smaller D_{C} than the first diameter D₁ and at least slightly larger (e.g., between about 0.001 and 0.003 inches) than each of the second diameter D₂ and the third diameter D₃, is axially inserted into the first opening 133 in the flange portion 131, the end of the conduit C first primarily engages the inner undulations 165 of the first sectors 161 for elastic radial expansion of the inner undulations. The reduced (i.e., non-uniform circumferential) initial contact between the conduit C and the seal device 130 facilitates elastic radial expansion of the inner undulations 165 without resort to any significant bulk compression or tensile stretching of the seal wall. In the illustrated embodiment, the outer undulations 166 of the second sectors 162 may extend axially inward beyond the inner undulations 165 of the first sectors 161 to the axially inner edge 139, such that the third opening 136 defined by the outer undulations 166 is positioned axially inward of the second opening 135 defined by the inner undulations 165. In such a configuration, the third diameter D₃ of the third opening 136 may be substantially equal to the second diameter D₂ of the second opening 135 (as is evident from the sealing device end view of FIG. 6). In other embodiments, the third diameter D₃ may be larger or smaller than second diameter D₂, while still allowing for sequential engagement of the conduit end with the inner and outer undulations.

Upon further axial insertion of the conduit C, the end of the conduit subsequently engages the outer undulations 166 of the second sectors 162 for elastic radial expansion of the outer undulations. When the conduit is fully inserted through the seal device 130, the elastically radially expanded inner and outer undulations 165, 166 form a continuous circumferential seal around the conduit. The inner edge 139 may be contoured (e.g., beveled) to provide for single line sealing contact around the inserted conduit, which may, but need not, be undulating single line sealing contact.

While the undulating skirt portion may be provided with a uniform thickness around the circumference (e.g., in both first sectors and second sectors), in other embodiments, the first sectors, having inner undulations, may be provided with a smaller wall thickness to allow for greater radial deflection, and the second sectors, having outer undulations, may be provided with a greater wall thickness to provide for greater elastic radial compression despite a smaller amount of radial expansion (e.g., in embodiments for which the third opening diameter defined by the outer undulations is larger than the second opening diameter defined by the inner undulations). In one such embodiment, the second and third openings are axially aligned, with the inner undulations defining a smaller opening and having a smaller wall thickness, and the outer undulations defining a larger opening and having a greater wall thickness. Alternatively, the seal device may be provided with the inner undulations having a greater wall thickness and the outer undulations having a smaller wall thickness. Further, wall thickness may additionally or alternatively vary radially from the outer skirt to the seal rim to further facilitate uniform circumferential seal rim contact about the inserted conduit.

To further provide for predominantly flexure-type deformation of the seal device skirt portion, and to minimize bulk compression and/or tensile stress deformation of the seal device skirt portion, the skirt portion may be provided with a substantially or generally constant locus length around its circumference. To that end, as illustrated in a first cross-sectional views of FIGS. 7 and 8, first sectors 161 of the seal device skirt portion 134 having an inner undulation 165 or “valley” at the axially inner edge 139 may be provided with an intermediate outer undulation 167 or “peak” (e.g., between the proximal and distal portions 137, 138 of the skirt portion 134) and second sectors 162 of the skirt portion 134 having an outer undulation 166 or “peak” at the axially inner edge may be provided with an intermediate inner undulation 168 or “valley” (e.g., between the proximal and distal portions 137, 138 of the skirt portion 134). In this manner, the locus lengths L₁, L₂ of the sealing device skirt portion 134, measured from the first opening 133 to the axial edge 139, are generally constant, whether measured in a first sector 161 or a second sector 162.

FIG. 9 illustrates a partial cross-sectional view of an exemplary single action push-to-connect fitting assembly 100 including a fitting body 115, a conduit retaining arrangement 190, and the seal device 130 of FIGS. 5-8. The fitting assembly 100 shares many common elements as the embodiments of the '602 and '932 Applications and may additionally or alternatively include additional features of the various embodiments of the above incorporated '659, '385, '602, and '932 Applications (e.g., the colleting or secondary gripping features of the retainers of the '602 and '932 Applications).

The exemplary fitting body 115 includes a male threaded first fitting component 120 and a mating second fitting component 150 in the form of a female threaded nut. Although in all the exemplary embodiments herein we show threaded mechanical connections between the first fitting component and the second fitting component, non-threaded connections may alternatively be used, for example, crimped or welded connections.

The male threaded first fitting component 120 includes a conduit end socket 122 and may optionally present a counterbore shoulder 124 against which the conduit is bottomed in the final assembled condition. The male threaded first fitting component 120 and female threaded second fitting component 150 together define an interior cavity 123 in which is disposed the seal device 130, to provide a fluid tight seal against the conduit C when the fitting connection is complete.

The conduit retaining arrangement 190 includes a retainer 140 that may be similar to the retainers of the embodiments of the '602 and '932 Applications. The exemplary retainer 140 includes a carrier 142, one or more conduit gripping members 144, for example, in the form of spherical balls disposed in corresponding cavities 144a in the carrier 142, a biasing member 145 (e.g., a coil compression spring), a backing ring 146 installed between the male threaded body 120 and the female threaded nut 150 for clamping and sealing retention of the seal device 130, and an extension gland 148 disposed between the carrier 142 and the skirt portion 134 of the seal device 130. As shown, the backing ring 146 may be provided with a conical surface 147 adjacent to the outboard surface of the seal device skirt portion 134, to serve as a support ring or support member for the thin walled skirt portion, limiting outboard axial deformation of the skirt portion. In other embodiments, other components may function as an outboard support member (e.g., the extension gland). Similarly, the first fitting component 120 may be provided with a conical end surface 127 adjacent to the inboard surface of the seal device skirt portion 134, to serve as a support ring or support member for the thin walled skirt portion, limiting inboard axial deformation of the skirt portion. In other embodiments, other components may function as an inboard support member (e.g., an additional gland installed between the seal device and the fitting body).

The carrier 142, under the axial force provided by the biasing member 145 against the clamped backing ring 146, axially forces the gripping members 144 into engagement with a tapered interior surface 152 presented in the female threaded nut 150. The carrier 142 axially aligns and positions the gripping members 144 relative to the tapered interior surface 152 so that after the conduit C is inserted past the gripping members, the gripping members are trapped between the tapered interior surface 152 and the outer surface of the conduit C. Therefore, the inserted conduit C cannot be withdrawn from the fitting assembly 100.

When pressurized, the fluid pressure applies an axial force on the skirt portion 134 of the seal device 130 for increased sealing engagement of the skirt portion inner edge 139 with the conduit C. This axial force against the skirt portion 134 may also be transmitted through the gland 148 to the carrier 142, thereby radially forcing the gripping members 144 into increased gripping engagement with the conduit C. In other embodiments (not shown) the extension gland may be integral with the carrier. Additionally or alternatively, the system fluid pressure may result in a slight axial outward movement of the conduit. This movement may cause the skirt portion inner edge to more aggressively grip the conduit, and may (but need not) create a circumferential indentation in the conduit, as described in greater detail below.

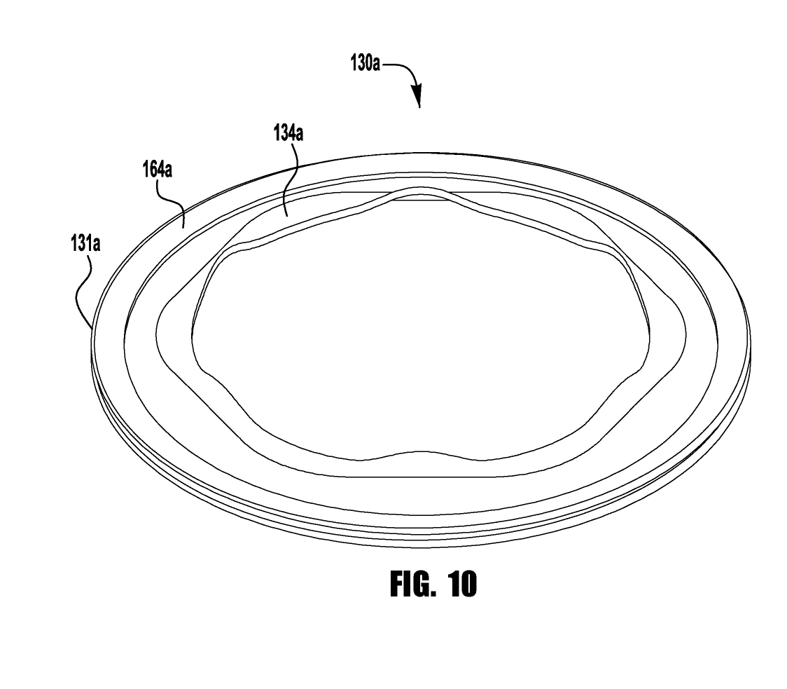

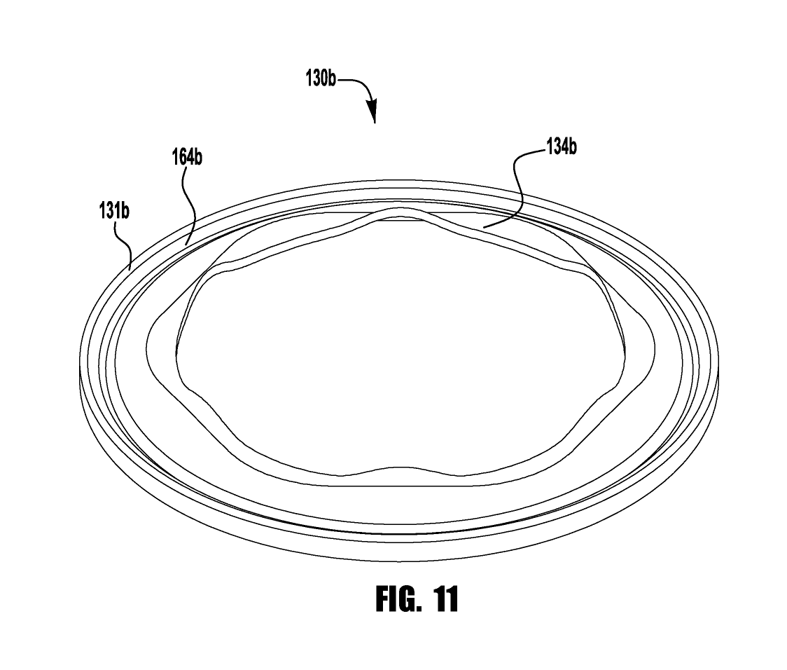

To release the conduit C from the fitting assembly 100, an axially inward force may be applied to the carrier 142, moving the gripping members 144 axially inward along the tapered interior surface 152 to permit radially outward movement of the gripping members away from the conduit surface, and moving the extension gland 148 against the inner radial portion of the skirt portion 134 for radially outward flexing of the skirt portion away from the conduit surface. This axial inward force may be applied by insertion of a tool (not shown) into the outboard end of the nut 150, through a gap disposed between the nut bore and the inserted conduit C (an example of which is shown and described in the above incorporated '932 Application, see FIG. 11G and corresponding description). In another embodiment (not shown), the carrier may include an outboard flange extending axially outward of the outboard end of the nut, such that the outboard flange may be axially pressed by the user to apply the axially inward force to the carrier (an example of which is shown and described in the above incorporated '932 Application, see FIGS. 10A-10C and corresponding description). In some applications, the fitting arrangement may allow for remake of the fitting using the same conduit end or a new conduit end, using the same push-to-connect procedure.

To facilitate assembly and disassembly of the push-to-connect fitting assembly, one or more of the internal fitting components may be retained with one of the fitting body and fitting nut as a discrete subassembly, when the one of the fitting body and fitting nut is disassembled from, or assembled with, the other of the fitting body and fitting nut. For example, the backup ring 146 may be attached to the nut 150 (e.g., by staking, welding, press fit engagement, etc.) to retain the nut 150, retainer 142, gripping members 144, biasing member 145, and backup ring 146 together as a subassembly. As another example, the seal device 130 may be attached to the nut (e.g., by staking, welding, press fit engagement, etc.) to retain the nut 150, retainer 142, gripping members 144, biasing member 145, backup ring 146, and seal device 130 together as a subassembly. As still another example, the seal device 130 may be attached to the fitting body 120 (e.g., by welding, staking, etc.) to retain the fitting body 120 and seal device 130 together as a subassembly.

FIG. 9A illustrates a partial cross-sectional view of another exemplary single action push-to-connect fitting assembly 100′, similar to the assembly of FIG. 9 (and having reference numbers consistent therewith), but including a retainer 142′ having a second set of cavities 143a′ retaining a set of colleting members 143′ (e.g., balls, spheres, or other bearing members) outboard of the gripping members and configured to collet the conduit or to provide isolation of conduit vibration and flex from the gripping members 144′ (first ball set). These colleting members 143′ may be adapted to provide increased surface area contact (e.g., by utilizing a larger number of colleting balls), as compared to the gripping members, to securely hold or collet this outboard portion of the conduit against radial or lateral movement while reducing or minimizing indentation of the outboard conduit portion.

FIG. 9B illustrates a partial cross-sectional view of another exemplary single action push-to-connect fitting assembly 100″, similar to the assemblies of FIGS. 9 and 9A (and having reference numbers consistent therewith), but including a retainer 142″ having a set of axially extending, radially flexible members 143″ outboard of the gripping members 144″ that are flexed into colleting engagement with the conduit by spring biased engagement with the tapered interior surface 152″ of the nut 150″, to collet the conduit or to provide isolation of conduit vibration and flex from the gripping members 144″ (first ball set). These flexible colleting members 143″ may, but need not, be integral with the retainer 142″, and may be adapted to provide increased surface area contact (e.g., by utilizing a larger number of flexible members, and/or larger contacting surfaces), as compared to the gripping members, to securely hold or collet this outboard portion of the conduit against radial or lateral movement while reducing or minimizing indentation of the outboard conduit portion.

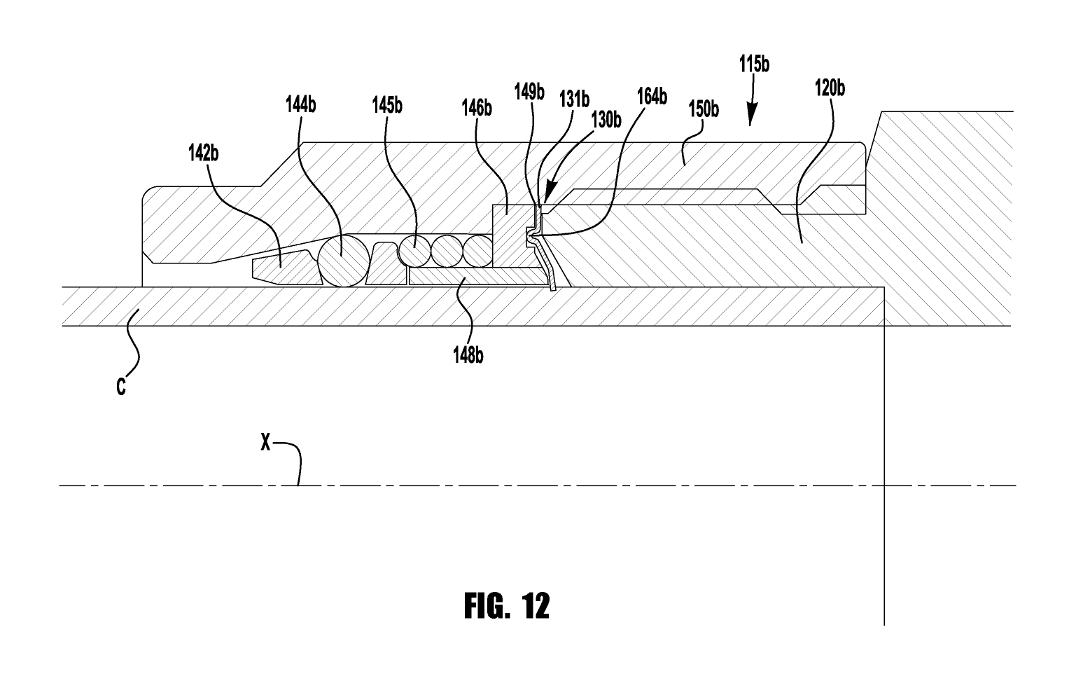

According to another aspect of the present application, a seal device may include a convolution radially outward of the skirt portion to function as a hinge portion, for example, to reduce stresses in the seal device upon sealing deformation. In one embodiment, as shown in FIG. 10, a seal device 130a may include a hinging convolution 164a extending in an axially inward direction (i.e., the same direction as the skirt portion 134a). In another embodiment, as shown in FIG. 11, a seal device 130b may include a hinging convolution 164b extending in an axially outward direction (i.e., away from the skirt portion 134b). As shown in FIG. 12, the backing ring 146b may include an annular groove 149b sized to accommodate the convolution 164b.

In some applications, the inner sealing edge of the seal device may produce a sealing indentation in the outer surface of the inserted conduit. This may occur upon conduit insertion, or in response to system fluid pressurization (e.g., as a result of slight axial outward movement of the conduit within the fitting, as discussed above). According to another aspect of the present application, a seal device may be configured to accommodate axial movement of the inner sealing edge, for example, to allow the inner sealing edge of the seal device to move axially with the sealing indentation in the inserted cylindrical component (e.g., conduit, or valve or actuator stem), for example, in applications where the inserted cylindrical component is subjected to axial movement (e.g., due to pressure fluctuations, valve cycling, etc.). While many different arrangements may provide for axial movement of the seal device sealing portion, in one embodiment, a seal device may be provided with an axially flexible bellows portion disposed between the inner sealing edge of the seal device and the axially fixed flange portion.

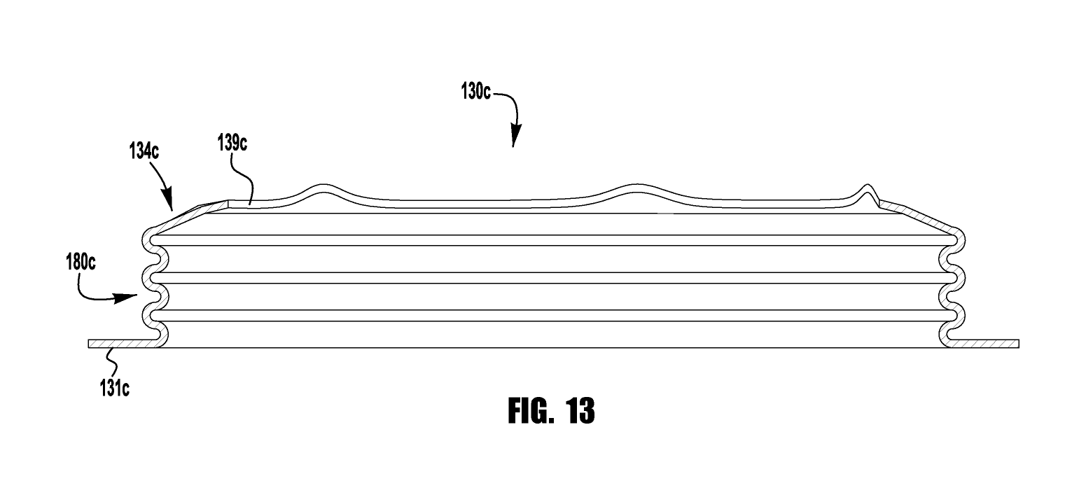

FIG. 13 illustrates a cross-sectional view of an exemplary seal device 130c including an outboard annular flange portion 131c (which may, but need not, be similar to the flange portion(s) of one or more of the seal devices of FIGS. 5-12), a skirt portion 134c (which may, but need not, be similar to the flange portion(s) of one or more of the seal devices of FIGS. 5-12), and a bellows portion 180c extending between the flange portion 131c and the skirt portion 134c. The bellows portion 180c is axially flexible to accommodate axial movement of the inner sealing edge 139c, for example, to allow the inner sealing edge of the seal device 130c to move axially with the sealing indentation in the inserted cylindrical component (e.g., conduit, or valve or actuator stem), for example, in applications where the inserted cylindrical component is subjected to axial movement (e.g., due to pressure fluctuations, valve cycling, etc.).

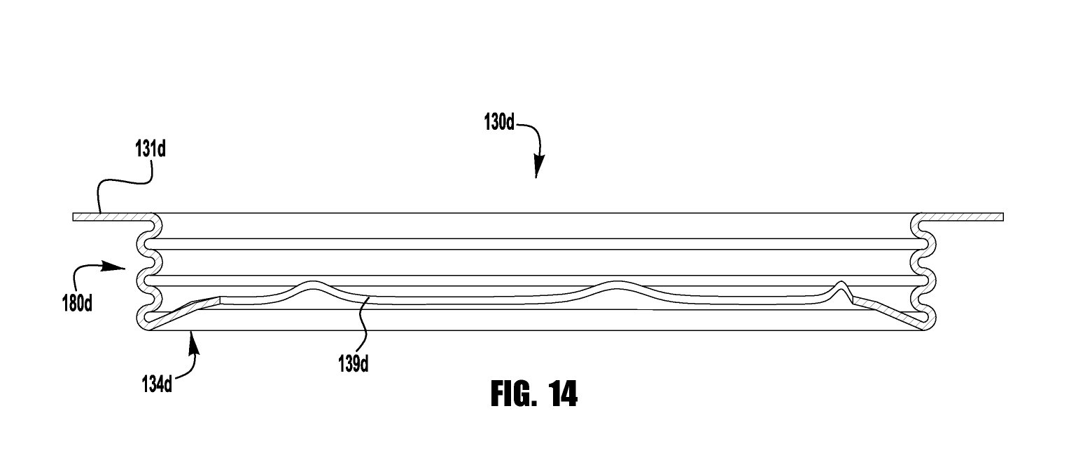

In another embodiment, a seal device may be provided with an inboard flange portion and an outboard skirt portion, such that an inserted cylindrical component is first received through the skirt portion before passing through the inboard flange portion. FIG. 14 illustrates a cross-sectional view of an exemplary seal device 130d including an inboard annular flange portion 131d (which may, but need not, be similar to the flange portion(s) of one or more of the seal devices of FIGS. 5-12), a skirt portion 134d (which may, but need not, be similar to the flange portion(s) of one or more of the seal devices of FIGS. 5-12), and a bellows portion 180d extending between the flange portion 131d and the skirt portion 134d. As shown, the skirt portion 134d is inverted relative to the skirt portion 134c of the seal device 130c of FIG. 13. The bellows portion 180d is axially flexible to accommodate axial movement of the inner sealing edge 139d, for example, to allow the inner sealing edge of the seal device 130d to move axially with the sealing indentation in the inserted cylindrical component (e.g., conduit, or valve or actuator stem), for example, in applications where the inserted cylindrical component is subjected to axial movement (e.g., due to pressure fluctuations, valve cycling, etc.).

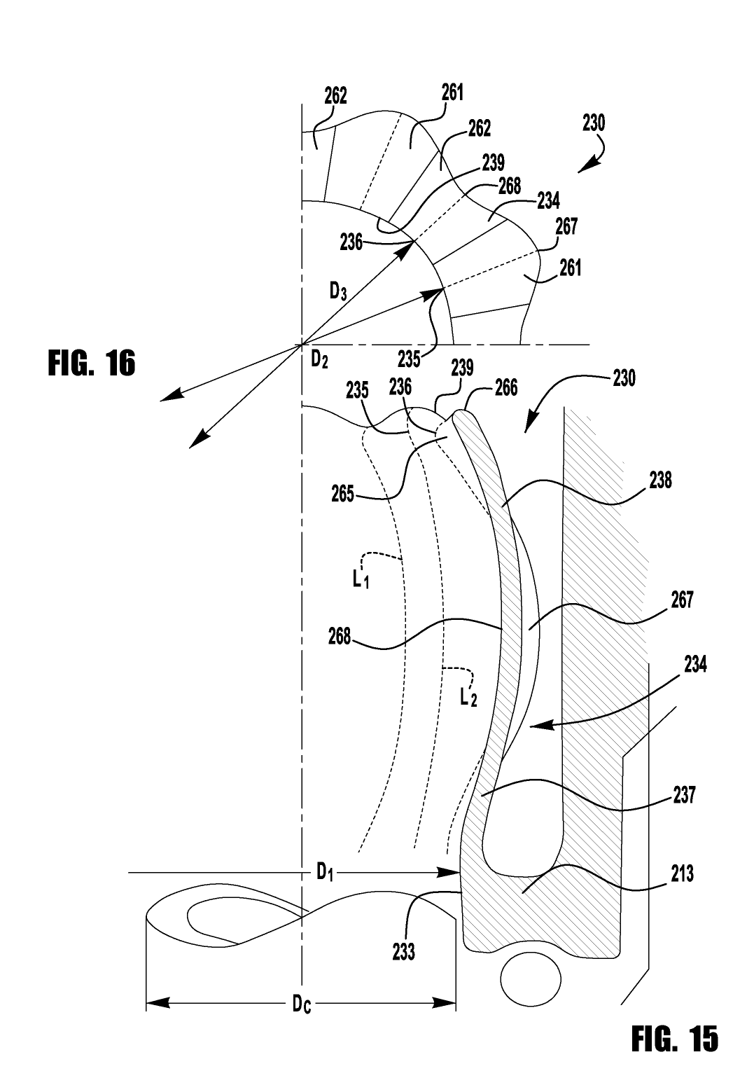

FIGS. 15 and 16 illustrates an exemplary barrel-shaped seal device 230 (similar to the sealing device 30′ of FIGS. 3 and 4) including an annular flange portion 231 defining a first opening 233 having a first diameter D₁, sized for insertion of a conduit C (or other cylindrical component) through the annular flange portion, and a skirt portion 234 integral with the annular flange portion 231 and extending axially and radially inward from the flange portion. The skirt portion 234 includes a proximal portion 237 that extends radially outward at a first angle to a radially outermost portion of the barrel shaped skirt, and a distal portion 238 that extends radially inward at a second angle toward an axially inner edge 239 (for example to facilitate radially outward flexing of the skirt portion by the inserted conduit C), such that the skirt portion 234 forms a barrel shape.

The skirt portion 234 includes a plurality of first sectors 261 extending axially inward from the flange portion to an axially inner edge 239 of the skirt portion. Each of the first sectors 261 includes an inner undulation 265 (or “valley”), with the inner undulations together defining a second opening 235 having a second diameter D₂ smaller than the first diameter D₁, and smaller than the outer diameter D_{C} of the inserted conduit C. The first sectors 261 are circumferentially spaced apart by a plurality of second sectors 262 extending axially inward from the flange portion 231 to the axially inner edge 239 of the skirt portion 234. Each of the second sectors 262 includes an outer undulation 266 (or “peak”), with the outer undulations together defining a third opening 236 having a third diameter D₃ smaller than the first diameter D₁ and smaller than the outer diameter D_{C} of the inserted conduit C.

The seal device 230 may be configured such that when a conduit C (or other cylindrical component), having a diameter smaller D_{C} than the first diameter D₁ and at least slightly larger (e.g., between about 0.001 and 0.003 inches) than each of the second diameter D₂ and the third diameter D₃, is axially inserted into the first opening 233 in the flange portion 231, the end of the conduit C first primarily engages the inner undulations 265 of the first sectors 261 for elastic radial expansion of the inner undulations. The reduced (i.e., non-uniform circumferential) initial contact between the conduit C and the seal device 230 facilitates elastic radial expansion of the inner undulations 265 without resort to any significant bulk compression or tensile stretching of the seal wall. In the illustrated embodiment, the outer undulations 266 of the second sectors 262 may extend axially inward beyond the inner undulations 265 of the first sectors 261 to the axially inner edge 239, such that the third opening 236 defined by the outer undulations 266 is positioned axially inward of the second opening 235 defined by the inner undulations 265. In such a configuration, the third diameter D₃ of the third opening 236 may be substantially equal to the second diameter D₂ of the second opening 235 (as is evident from the sealing device end view of FIG. 11). In other embodiments, the third diameter D₃ may be larger or smaller than second diameter D₂, while still allowing for sequential engagement of the conduit end with the inner and outer undulations.

Upon further axial insertion of the conduit C, the end of the conduit subsequently engages the outer undulations 266 of the second sectors 262 for elastic radial expansion of the outer undulations. When the conduit is fully inserted through the seal device 230, the elastically radially expanded inner and outer undulations 265, 266 form a continuous circumferential seal around the conduit. The inner edge 239 may be contoured (e.g., beveled) to provide for single line sealing contact around the inserted conduit, which may, but need not, be undulating single line sealing contact.

While the undulating skirt portion may be provided with a uniform thickness around the circumference (e.g., in both first sectors and second sectors), in other embodiments, the first sectors, having inner undulations, may be provided with a smaller wall thickness to allow for greater radial deflection, and the second sectors, having outer undulations, may be provided with a greater wall thickness to provide for greater elastic radial compression despite a smaller amount of radial expansion (e.g., in embodiments for which the third opening diameter defined by the outer undulations is larger than the second opening diameter defined by the inner undulations). In one such embodiment, the second and third openings are axially aligned, with the inner undulations defining a smaller opening and having a smaller wall thickness, and the outer undulations defining a larger opening and having a greater wall thickness. Alternatively, the seal device may be provided with the inner undulations having a greater wall thickness and the outer undulations having a smaller wall thickness. Further, wall thickness may additionally or alternatively vary radially from the outer skirt to the seal rim to further facilitate uniform circumferential seal rim contact about the inserted conduit.

To further provide for predominantly flexure-type deformation of the seal device skirt portion, and to minimize bulk compression and/or tensile stress deformation of the seal device skirt portion, the skirt portion may be provided with a substantially or generally constant locus length around its circumference. To that end, first sectors 261 of the seal device skirt portion 234 having an inner undulation 265 or “valley” at the axially inner edge 239 may be provided with an intermediate outer undulation 267 or “peak” at the radially outermost portion of the barrel shaped skirt, and second sectors 262 of the skirt portion 234 having an outer undulation 266 or “peak” at the axially inner edge may be provided with an intermediate inner undulation 268 or “valley” at the radially outermost portion of the barrel shaped skirt. In this manner, the locus lengths L₁, L₂ of the sealing device skirt portion 234, measured from the first opening 233 to the axial edge 239, are generally constant, whether measured in a first sector 261 or a second sector 262.

The inventive aspects and concepts have been described with reference to the exemplary embodiments. Modification and alterations will occur to others upon a reading and understanding of this specification. It is intended to include all such modifications and alterations insofar as they come within the scope of the appended claims or the equivalents thereof.

1. A seal device for sealing a cylindrical component upon axial insertion of the cylindrical component, the seal device comprising:
an annular flange portion defining a first opening having a first diameter; and
a skirt portion integral with the annular flange portion and extending axially and radially inward from the flange portion, the skirt portion including a plurality of first sectors extending axially inward from the flange portion to an axially inner edge of the skirt portion, each having an inner undulation defining a second opening having a second diameter smaller than the first diameter, the plurality of first sectors being circumferentially spaced apart by a plurality of second sectors extending axially inward from the flange portion to the axially inner edge of the skirt portion, each having an outer undulation defining a third opening having a third diameter smaller than the first diameter.

2. The seal device of claim 1, wherein when a cylindrical component having a diameter smaller than the first diameter and larger than each of the second diameter and the third diameter is axially inserted through the first opening and against the inner and outer undulations of the skirt portion, the inner undulations of the plurality of first sectors and the outer undulations of the plurality of second sectors are elastically radially expanded by the cylindrical component to form a continuous circumferential seal around the cylindrical component.

3. The seal device of claim 1, wherein the third diameter is larger than the second diameter.

4. The seal device of claim 1, wherein the third diameter is substantially equal to the second diameter.

5. The seal device of claim 1, wherein the third opening is axially inward of the second opening.

6. The seal device of claim 1, wherein the skirt portion comprises a proximal tapered portion and a distal tapered portion angled with respect to the proximal tapered portion.

7. The seal device of claim 6, wherein the skirt portion comprises a proximal tapered portion and a distal tapered portion angled radially inward with respect to the proximal tapered portion.

8. The seal device of claim 6, wherein the plurality of inner undulations and the plurality of outer undulations are disposed on the distal tapered portion of the skirt portion.

9. The seal device of claim 6, wherein each of the plurality of first sectors comprises an intermediate outer undulation disposed on the proximal tapered portion, and each of the plurality of second sectors comprises an intermediate inner undulation disposed on the proximal tapered portion.

10. The seal device of claim 6, wherein the proximal tapered portion extends radially inward at an angle of approximately 30° to approximately 60° with respect to a central axis.

11. The seal device of claim 6, wherein the proximal tapered portion extends radially outward at an angle of approximately 0° to approximately 20° with respect to a central axis.

12. The seal device of claim 6, wherein the distal tapered portion extends radially inward at an angle of approximately 40° to approximately 80° with respect to a central axis.

13. The seal device of claim 6, wherein the distal tapered portion extends radially inward at an angle of approximately 10° to approximately 50° with respect to a central axis.

14. (canceled)

15. The seal device of claim 1, wherein each of the plurality of first sectors has a first locus length from the flange portion to the axially inner edge of the skirt portion, and each of the plurality of second sectors has a second locus length from the flange portion to the axially inner edge of the skirt portion, wherein the first locus length is substantially equal to the second locus length.

16. (canceled)

17. The seal device of claim 1, wherein the skirt portion includes a barrel-shaped portion extending between the first opening and the second opening.

18. The seal device of claim 1, wherein the seal device comprises at least one of high yield tensile strength steels (e.g., A514, A588, A852, etc.), 316 stainless steel, 300 stainless steel, 400 stainless steel, 6 Moly stainless steel, Inconel 625, Incoloy 825, brass, copper alloy, low alloy steels, aluminum, aluminum alloys, titanium, magnesium, gold, silver platinum, plutonium, uranium, tantalum, nickel, zinc, tin, and plastic.

19. The seal device of claim 1, wherein the skirt portion has a substantially uniform wall thickness.

20. The seal device of claim 1, wherein the axially inner edge of the skirt portion includes a beveled inner diameter.

21. The seal device of claim 1, wherein the annular flange portion is integrally formed with a fitting component sized to receive a conduit.

22. A push to connect fitting assembly for a conduit having a longitudinal axis, the fitting assembly comprising:
a fitting body having an outboard end that is adapted to receive a conduit end, the fitting body at least partially defining an interior cavity; and
a seal device disposed in the interior cavity, the seal device comprising an annular flange portion joined with the fitting body and defining a first opening having a first diameter, and a skirt portion extending axially and radially inward from the annular flange portion to define a second opening having a second diameter smaller than the first diameter;
wherein when a conduit having a diameter smaller than the first diameter and larger than the second diameter is axially inserted through the first opening and against an interior surface of the skirt portion, the skirt portion is elastically radially expanded by the conduit to form a continuous circumferential seal around the conduit.

23-45. (canceled)

46. A method of making a seal device for sealing a cylindrical component upon axial insertion of the cylindrical component, the method comprising:
forming an annular flange portion defining a first opening having a first diameter; and
forming a skirt portion integral with the annular flange portion and extending axially and radially inward from the flange portion, the skirt portion including a plurality of first sectors extending axially inward from the flange portion to an axially inner edge of the skirt portion, each having an inner undulation defining a second opening having a second diameter smaller than the first diameter, the plurality of first sectors being circumferentially spaced apart by a plurality of second sectors extending axially inward from the flange portion to the axially inner edge of the skirt portion, each having an outer undulation defining a third opening having a third diameter smaller than the first diameter.

47-49. (canceled)

50. A method of providing a push-to-connect seal between a conduit end and a fitting, the method comprising:
providing a fitting including a fitting body having an outboard end that is adapted to receive a conduit end, and a seal device disposed in an interior cavity of the fitting body, the seal device comprising an annular flange portion joined with the fitting body and defining a first opening having a first diameter, and a skirt portion extending axially and radially inward from the annular flange portion to define a second opening having a second diameter smaller than the first diameter; and
axially inserting a conduit having a diameter smaller than the first diameter and larger than the second diameter through the first opening and against an interior surface of the skirt portion, such that the skirt portion is elastically radially expanded by the conduit to form a continuous circumferential seal around the conduit.

51-61. (canceled)
